(19) United States
(12) Patent Application Publication
(10) Pub. No.: US 2026/0350585 A1
(43) Pub. Date: Nov. 5, 2026

(54) DYNAMIC MOBILE WALLET CARD SHARING

(71) Applicant: Impiricushealth Corp., Atlanta, GA (US)

(72) Inventors: Or Maoz, Atlanta, GA (US); Rafay Chaudhary, Atlanta, GA (US); Alan George Labouseur, Pleasant Valley, NY (US); Lotem Gayus Shive, Cumming, GA (US); Kok Seng Tan, Arlington, VA (US); Jennifer Marie Bridwell, Louisville, KY (US); Casey Marie White, Boston, MA (US); Kristi Briana Dunlap, Atlanta, GA (US)

(21) Appl. No.: 19/195,815

(22) Filed: May 1, 2025

(51) Int. Cl. G06Q 20/36; G06Q 20/34

(52) U.S. Cl. CPC G06Q 20/36; G06Q 20/351

(57) ABSTRACT

Disclosed are various embodiments for dynamic mobile wallet card sharing. A computing device can receive a child card request. In response to receipt of the child card request, the computing device can identify a parent identifier and a card identifier based at least in part on the child card request. The computing device can then establish a connection with a wallet application and issue, to the wallet application, a child card based at least in part on the parent identifier and the card identifier.

### BACKGROUND

When a person or organization wishes to share relevant information with another person or organization, such as vouchers, educational materials, news articles, etc., it can often be difficult to share the information in a readily accessible way. In some cases, sharing the information electronically can involve additional steps, such as downloading an application, visiting an external website, etc. Additionally, sharing the information through electronic methods of communication such as email, text, etc., often involves searching through a number of previous messages to find the relevant information. This can be a challenging and time-consuming process with great difficulty. Similarly, sharing physical information, such as printed articles, promotional materials, etc., can be challenging as well. In some cases, the person can misplace or lose the information, and it could be difficult to replace.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A and 1B are pictorial diagrams of an example user interface rendered by a client device according to various embodiments of the present disclosure. FIG. 1A shows an example user interface rendered by a client device when an example child card is issued to the user after the user activates a child card request according to various embodiments of the present disclosure. FIG. 1B shows an example user interface rendered by a client device when an example parent card is issued to the user after the user activates a parent card request according to various embodiments of the present disclosure.

FIG. 2 is a pictorial diagram of an example user interface rendered by a client device according to various embodiments of the present disclosure.

FIG. 3 is a drawing of a network environment according to various embodiments of the present disclosure.

FIGS. 4A-4C are sequence diagrams illustrating one example of interactions between applications executed in a computing environment in the network environment of FIG. 3 according to various embodiments of the present disclosure.

FIG. 5 is a flowchart illustrating one example of functionality implemented as a portion of an application executed in a computing environment in the network environment of FIG. 3 according to various embodiments of the present disclosure.

FIG. 6 is a flowchart illustrating one example of functionality implemented as a portion of an application executed in a computing environment in the network environment of FIG. 3 according to various embodiments of the present disclosure.

### DETAILED DESCRIPTION

Disclosed are various approaches for dynamic mobile wallet card sharing. When a person or organization wishes to share relevant information with another person or organization, such as vouchers, educational materials, news articles, etc., the person or organization could be unable to share or save relevant information in an accessible way. Traditional electronic methods of communication, such as email, text, etc., can often involve additional steps (e.g., downloading an app, accessing an external link, etc.) or time-consuming searching through numerous messages to find previously shared information. Similarly, sharing physical media for information (e.g., printed vouchers, articles, books, etc.) can result in the media being lost, damaged, or misplaced, which can be difficult to replace in some instances.

Digital wallets can allow users to store multiple types of digital cards (e.g., credit cards, coupons, tickets, identification documents, etc.) in a central location. The digital cards can be used to allow the user to make contactless transactions or readily access important information with his or her mobile device. Digital cards (also referred to as “digital wallet cards”) can also be readily and easily shared between various devices or users. In some cases, a code (e.g., a matrix bar code such as a quick-response (QR) code, a linear barcode, a data matrix, etc.) can be scanned or a link can be accessed to add a digital wallet card to a wallet application.

However, a person or organization could want to provide another person or organization with a digital card that easily and readily generates unique cards linked to the digital card. For example, a pharmaceutical company could want to provide a doctor with discount vouchers to distribute to patients in a way that the company could track and monitor the distributed vouchers. In this example, it can be difficult for the pharmaceutical company to provide the doctor with a digital card that patients can use to easily obtain unique voucher cards that are associated with the doctor's original card. Further, it could be difficult for the pharmaceutical company to monitor the distributed voucher cards and modify the cards in response to certain events (e.g., expiration of the offer, offer modifications, patient use of the offer, etc.).

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

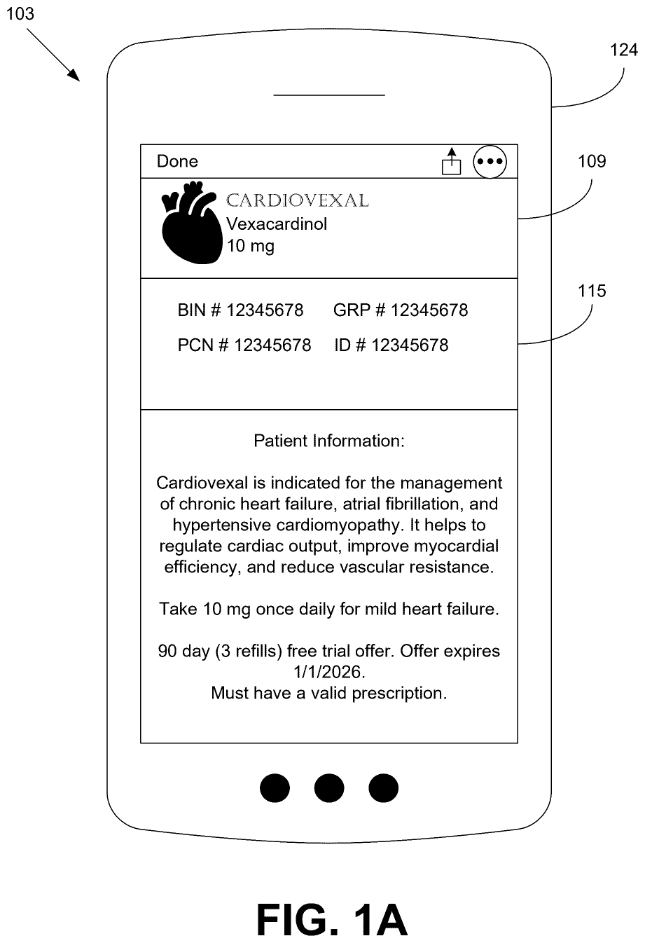

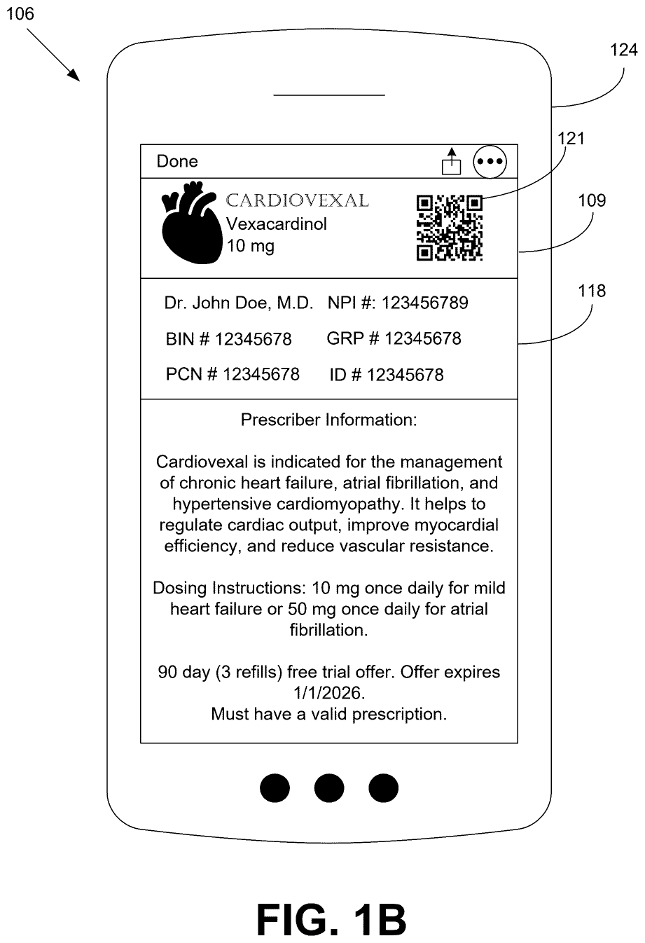

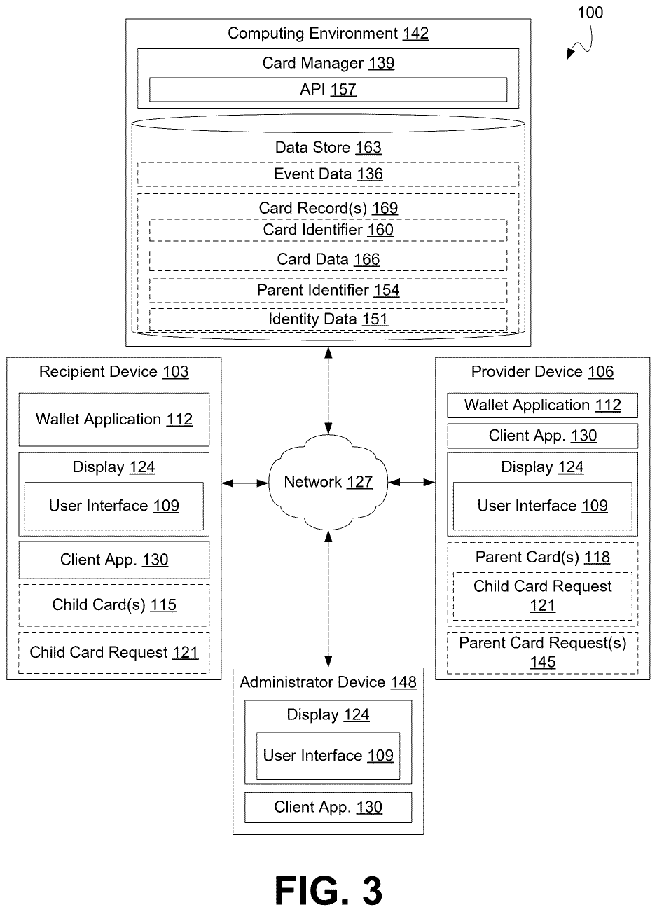

FIGS. 1A and 1B illustrate an example of the user interface 109 that can be generated by the wallet application 112 and rendered on a recipient device 103 after issuance of a child card 115 (FIG. 1A) or on a provider device 106 after issuance of a parent card 118 (FIG. 1B) within the network environment 100 of FIG. 3. In some examples, the parent card 118 can have a child card request 121 encoded in a code displayed on the user interface 109.

Referring first to FIG. 1A, shown is an example of a child card 115 rendered on a display 124 of a recipient device 103. The child card 115 can have a variety of information specific to the child card 115 displayed. In some examples, the child card 115 can have offer details, terms and conditions, patient instructions, insurance information, or other patient-specific information. For example, a child card 115 can be issued to a patient for a voucher for an example drug, Cardiovexal. The child card 115 for the voucher for Cardiovexal could have dosage information, insurance information provided by the drug manufacturer (e.g., a bank identification number (BIN), a processor control number (PCN), a group number (GRP), an identification number (ID), etc.), contraindications, an offer expiration date, or other offer requirements (e.g., number of refills, length of offer availability, prescription requirements, etc.).

Referring next to FIG. 1B, shown is an example of a parent card 118 rendered on a display 124 of a provider device 106. The parent card 118 can have a variety of information specific to the parent card 118 displayed. In some examples, the parent card 118 can display an encoded child card request 121 that can cause a recipient device 103 to submit a child card request 121 when the recipient device 103 scans or reads the code displayed on the provider device 106. In some examples, a child card 115 can be generated and provided to the recipient device 103 in real time once a child card request 121 is submitted by the recipient device 103. In some examples, the parent card 118 can have prescriber information, offer details, terms and conditions, dosing instructions, prescriber details, or other prescriber-specific information. For example, a parent card 118 can be issued to a doctor for providing patients with a voucher for an example drug, Cardiovexal. The parent card 118 could have dosage information, insurance information provided by the drug manufacturer (e.g., a bank identification number (BIN), a processor control number (PCN), a group number (GRP), an identification number (ID), etc.), contraindications, an offer expiration date, doctor-specific identification information (e.g., name, phone number, office address, a national provider identifier (NPI), or other offer requirements (e.g., number of refills, length of offer availability, prescription requirements, etc.).

A recipient device 103 is representative of a client device that can be coupled to a network 127. The recipient device 103 can include a processor-based system such as a computer system. Such a computer system can be embodied in the form of a personal computer (e.g., a desktop computer, a laptop computer, or similar device), a mobile computing device (e.g., personal digital assistants, smartphones, tablet computer systems, and similar devices), or other devices with like capability. The recipient device 103 can include one or more displays 124, such as liquid crystal displays (LCDs), gas plasma-based flat panel displays, organic light emitting diode (OLED) displays, electrophoretic ink (“E-ink”) displays, projectors, or other types of display devices. In some instances, the display 124 can be a component of the recipient device 103 or can be connected to the recipient device 103 through a wired or wireless connection. Moreover, the recipient device 103 can be configured to execute various applications such as a wallet application 112, a client application 130, or other applications.

A provider device 106 is representative of a client device that can be coupled to a network 127. The provider device 106 can include a processor-based system such as a computer system. Such a computer system can be embodied in the form of a personal computer (e.g., a desktop computer, a laptop computer, or similar device), a mobile computing device (e.g., personal digital assistants, smartphones, tablet computer systems, and similar devices), or other devices with like capability. The provider device 106 can include one or more displays 124, such as liquid crystal displays (LCDs), gas plasma-based flat panel displays, organic light emitting diode (OLED) displays, electrophoretic ink (“E-ink”) displays, projectors, or other types of display devices. In some instances, the display 124 can be a component of the provider device 106 or can be connected to the provider device 106 through a wired or wireless connection. Moreover, the provider device 106 can be configured to execute various applications such as a wallet application 112, a client application 130, or other applications.

The wallet application 112 can represent any application that allows a user to manage his or her digital cards 133. In some examples, the wallet application 112 and/or the client application 130 can be executed to monitor the recipient device 103 or the provider device 106 and user interactions with the recipient device 103 or the provider device 106. For example, the wallet application 112 and/or client application 130 can monitor event data 136 and/or data that can be monitored by the wallet application 112 and/or the client application 130 to allow the wallet application 112 and/or the client application 130 to detect event data 136. The wallet application 112 can also be executed to access or render a user interface 109 in which digital cards 133 issued by a card manager 139 can be viewed and managed by a user. The wallet application 112 could be a separate, standalone application or, in some implementations, could be an extension or plugin run by the client application 130.

The client application 130 can be executed by a client device, such as a recipient device 103 or a provider device 106, to access network content served up by the computing environment 142 or other servers, thereby rendering a user interface 109 on the display 124. To this end, the client application 130 can include a browser, a dedicated application, or other executable, and the user interface 109 can include a network page, an application screen, or other user mechanism for obtaining user input. The recipient device 103 or the provider device 106 can be configured to execute applications beyond the client application 130 such as email applications, social networking applications, word processors, spreadsheets, or other applications.

Also, various data can be stored on the recipient device 103 or the provider device 106 that is accessible to the wallet application 112 and/or the client application 130. The data can be stored in relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored on the recipient device 103 or the provider device 106 is associated with the operation of the various applications or functional entities described below. This data can include event data 136, one or more child cards 115, one or more parent cards 118, and potentially other data.

In some examples, the wallet application 112 and/or the client application 130 can monitor the recipient device 103 or the provider device 106, as well as user interactions with recipient device 103 or provider device 106, to detect event data 136 that can initiate the process for updating a child card 115 or a parent card 118. Event data 136 can be based at least in part on one or more factors including a time, a location, prior behavior, user defined settings, transaction data, an opening of a wallet application 112, and/or other types of data. In some examples, the wallet application 112 can analyze the factors using one or more prediction algorithms or trained prediction models to detect event data 136. In other examples, the wallet application 112 can detect the event data 136 in response to the occurrence of a given action, time, and/or date. For example, the wallet application 112 can detect event data 136 associated with a user using the child card 115 based at least in part on transaction data. In another example, the event data 136 can correspond to the user visiting a store (such as a pharmacy). In another example, the wallet application 112 can detect event data 136 corresponding to the date or time being outside of a predetermined amount of time for the child card 115 to be active.

A child card 115 can be a digital card 133 generated from and associated with a parent card 118. In some examples, a child card 115 can be generated in response to a child card request 121. In some examples, a parent card 118 can have a code (e.g., a matrix bar code such as a QR code, a linear barcode, a data matrix, etc.) or a link that, when scanned or activated by a user on the user interface 109 of a recipient device 103, causes the recipient device 103 to send a child card request 121 for a child card 115. For example, a child card 115 can be a voucher for a drug prescribed by a doctor and is issued to a patient after the patient scans the doctor's parent card 118 or activates a link from the parent card 118. In some examples, a child card 115 can be generated and issued in real time in response to a child card request 121. In some examples, a child card 115 is associated with a parent card 118 and can be remotely monitored or modified. For example, a pharmaceutical company can issue a parent card 118 to a doctor that, when scanned or activated by a patient, sends a child card request 121 for a child card 115 to issue to the patient. In this example, the pharmaceutical company could monitor the child card 115 associated with the parent card 118 by receiving event data 136. Further, in some examples, the pharmaceutical company could remotely modify the child card 115 based at least in part on event data 136.

A parent card 118 can be a digital card 133 generated for and issued to a user. In some examples, a parent card 118 can be generated in response to a parent card request 145. In some examples, a parent card 118 can have a code (e.g., a matrix bar code such as a QR code, a linear barcode, a data matrix, etc.) or a link that, when scanned or activated by a user on the user interface 109 of a recipient device 103, causes the recipient device 103 to send a child card request 121 for a child card 115. For example, a parent card 118 can be an information card for a drug and have a code or link for a voucher that can be issued to a patient after the patient scans the parent card 118 or activates a link from the parent card 118. In some examples, a parent card 118 is associated with one or more child cards 115 and can be remotely monitored or modified. For example, a pharmaceutical company can issue a parent card 118 to a doctor that, when scanned or activated by a patient, sends a child card request 121 for a child card 115 to issue to the patient. In this example, the pharmaceutical company could monitor the parent card 118 by receiving event data 136. Further, in some examples, the pharmaceutical company could remotely modify the parent card 118 based at least in part on event data 136.

A digital card 133 can be a virtual representation of a physical card, a compilation of information, or user credentials. In some examples, a digital card 133 could be a virtual representation of a payment card (e.g., a credit card, a debit card, a gift card, etc.). In other examples, a digital card 133 can be a virtual representation of a compilation of information (e.g., a voucher, an article, a dosing calculator, etc.). In some examples, a digital card 133 could be a virtual representation of user credentials (e.g., a license, a health card, a loyalty card, etc.). In some examples, a digital card 133 can be stored in a wallet application 112 on a client device, such as the recipient device 103 or the provider device 106. In some examples, a digital card 133 can be a child card 115 or a parent card 118.

A child card request 121 can represent data used to generate and issue a child card 115. In some examples, the child card request 121 can be a unique link (e.g., URL, deep link, a DIDComm invitation, etc.) having a parent identifier 154 and/or a card identifier 160 that, when accessed by a user, sends a request to the card manager 139 for a child card 115. In some examples, the card manager 139 generates a child card request 121 to be accessed by a recipient device 103. In some examples, the child card request 121 can be encoded in a code (e.g., a matrix bar code such as a QR code, a linear barcode, a data matrix, etc.) that a user scans with a recipient device 103 to send the child card request 121 to the card manager 139. In other examples, the child card request 121 can be a unique link sent by the card manager 129 to a user interface 109 on a recipient device 103. In some examples, the child card request 121 can be a unique link having a card identifier 160. In some examples, the child card request 121 can be a HTTPS request configured to be sent to an API 157 of the card manager 139. In some examples, a child card 115 can be generated and issued in real time once a child card request 121 is sent to the card manager 139.

A parent card request 145 can represent data used to generate and issue a parent card 118. In some examples, the parent card request 145 can be a unique link (e.g., URL, deep link, a DIDComm invitation, etc.) having a parent identifier 154 and/or a card identifier 160 that, when accessed by a user, sends a request to the card manager 139 for a parent card 118. In some examples, the card manager 139 generates a parent card request 145 to be accessed by a provider device 106. In some examples, the parent card request 145 can be encoded in a code (e.g., a matrix bar code such as a QR code, a linear barcode, a data matrix, etc.) that a user scans with a provider device 106 to send the parent card request 145 to the card manager 139. In other examples, the parent card request 145 can be a unique link sent by the card manager 139 to a user interface 109 on a provider device 106. In some examples, the parent card request 145 can be a unique link having a card identifier 160. In some examples, the parent card request 145 can be a HTTPS request configured to be sent to an API 157 of the card manager 139.

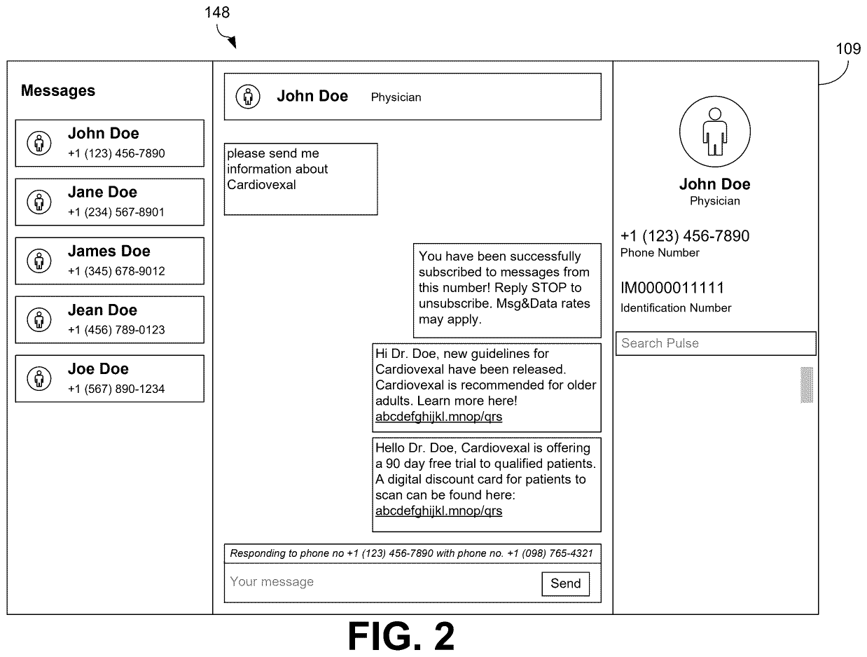

FIG. 2 illustrates an example of the user interface 109 that can be generated by the card manager 139 and rendered on an administrator device 148. The user interface 109 can illustrate how the card manager 139 can allow users (e.g., John Doe as shown in FIG. 2) to submit a parent card request 145, which can be submitted, in some examples, by accessing a link sent to the user through a short message service (SMS) text. For example, the example user interface 109 of FIG. 2 shows messages sent to a user who requested information related to an example drug, Cardiovexal, including a link to request a parent card 118. Additionally, a client or administrator can respond to a particular conversation with the user within the message thread shown within the user interface 109. In some examples, the user interface 109 can display relevant identification data 151 obtained by the card manager 139 from the user.

An administrator device 148 is representative of a client device that can be coupled to a network 127. The administrator device 148 can include a processor-based system such as a computer system. Such a computer system can be embodied in the form of a personal computer (e.g., a desktop computer, a laptop computer, or similar device), a mobile computing device (e.g., personal digital assistants, smartphones, tablet computer systems, and similar devices), or other devices with like capability. The administrator device 148 can include one or more displays 124, such as liquid crystal displays (LCDs), gas plasma-based flat panel displays, organic light emitting diode (OLED) displays, electrophoretic ink (“E-ink”) displays, projectors, or other types of display devices. In some instances, the display 124 can be a component of the provider device 106 or can be connected to the administrator device 148 through a wired or wireless connection. Moreover, the administrator device 148 can be configured to execute various applications such as a client application 130, or other applications.

In some examples, the administrator device 148 can be executed to access or render a user interface 109 in which conversations managed by the card manager 139 can be viewed and managed by a user. The client application 130 can represent a browser that accesses a web-based user interface 109 generated by the card manager 139 for administrators of the card manager 139. In some examples, the administrator device 148 can be executed to access or render a user interface 109 in which cards managed by the card manager 139 can be viewed and managed by a user. In some examples, a user could interact with the user interface 109 to modify, view, create, or delete child cards 115 or parent cards 118 managed by the card manager 139.

The card manager 139 can generate and send a plurality of parent card requests 145 distinct from one another based upon the phone number used as the originating number for the conversation. In some examples, the card manager 139 can identify parent card requests 145 as distinct from one another based upon a parent identifier 154 or identification data 151 associated with the phone number of the user.

With reference to FIG. 3, shown is a network environment 100 according to various embodiments. The network environment 100 can include a computing environment 142, one or more recipient devices 103, one or more provider devices 106, and one or more administrator devices 148, which can be in data communication with each other via a network 127.

The computing environment 142 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 142 can employ a plurality of computing devices that can be arranged in one or more server banks or computer banks or other arrangements. Such computing devices can be located in a single installation or can be distributed among many different geographical locations. For example, the computing environment 142 can include a plurality of computing devices that together can include a hosted computing resource, a grid computing resource or any other distributed computing arrangement. In some cases, the computing environment 142 can correspond to an elastic computing resource where the allotted capacity of processing, network, storage, or other computing-related resources can vary over time.

The network 127 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 127 can also include a combination of two or more networks 127. Examples of networks 127 can include the Internet, intranets, extranets, virtual private networks (VPNs), and similar networks.

Various applications or other functionality can be executed in the computing environment 142. The components executed on the computing environment 142 include a card manager 139 and other applications, services, processes, systems, engines, or functionality not discussed in detail herein.

The card manager 139 is a software application which can serve as a central hub or messaging platform which can interact with various databases, systems, services, or applications to generate, manage, and issue digital cards 133. The card manager 139 can be executed to perform a variety of functions according to various embodiments of the present disclosure. In some examples, the card manager 139 can include an application programming interface (API) 157. In some examples, the card manager 139 can be executed to receive a child card request 121, identify a parent identifier 154 and a card identifier 160 based at least in part on the child card request 121, establish a connection with a wallet application 112, and issue, to the wallet application 112, a child card 115 based at least in part on the parent identifier 154 and the card identifier 160. In some examples, the card manager 139 can be executed to receive event data 136 associated with the child card 115 and notify a user based at least in part on the event data 136 and the parent identifier 154. In some examples, the card manager 139 can be executed to receive a parent card request 145, identify a parent identifier 154 and a card identifier 160 based at least in part on the parent card request 145, establish a connection with a wallet application 112, and issue, to the wallet application 112, a parent card 118 based at least in part on the parent identifier 154 and the card identifier 160. In some examples, the card manager 139 can be executed to receive event data 136 associated with a child card 115 and update the child card 115 based at least in part on the event data 136. In some examples, the card manager 139 can be executed to receive event data 136 associated with a parent identifier 154 and update one or more child cards 115 associated with the parent identifier 154 based at least in part on the event data 136. In some examples, the card manager 139 can be executed to generate and issue a plurality of child cards 115 to a wallet application 112 associated with a user and/or generate and issue a plurality of parent cards 118 to a wallet application 112 associated with a parent identifier 154 of a user. In some examples, the card manager 139 can be executed to generate and issue a child card 115, or a parent card 118, to a wallet application 112 in real time.

In some examples, the card manager 139 can have an API 157 which serves to facilitate communications between various applications in the network environment 100. According to various examples, the API 157 can facilitate calls and responses between the card manager 139 and a data store 163. In some examples, the API 157 can facilitate calls and responses between the card manager 139 and a wallet application 112 or client application 130 on a recipient device 103 or a provider device 106.

Also, various data is stored in a data store 163 that is accessible to the computing environment 142. The data store 163 can be representative of a plurality of data stores 163 which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 163 is associated with the operation of the various applications or functional entities described below. This data can include one or more parent identifiers 154, identification data 151, event data 136, card data 166, one or more card identifiers 160, and potentially other data. In some examples, the data can include one or more card records 169 having a card identifier 160, card data 166, a parent identifier 154, identity data 151, or a combination of any thereof. The data store 163, though represented as a single data store, can be implemented as different data stores that are accessible through application programming interfaces that are managed by separate platforms. For example, card data 166 might be accessible through the card manager 139 or a corresponding API 157, while identification data 151 can be accessible through a separate platform that stores data about a user obtained from conversations from the messaging platform and client devices, such as recipient devices 103 and provider devices 106.

Identification data 151 can correspond to information about the end users who are receiving digital cards 133. Identification data 151 can include identifiers associated with a user, demographic information, marketing parameters, such as the types of products in which a user is interested, a professional specialty of the user, brands in which the user is interested, etc. In addition, identification data 151 can include numbers, addresses or other contact information to facilitate communication as well as one or more opt-out statuses for each user which indicate whether the user has opted-out of communications for various digital cards 133. In some examples, the identification data 151 can include a national provider identifier (NPI) associated with a user.

The parent identifier 154 can represent an alphanumeric or numeric code assigned to an entity to which a parent card 118 will be issued (e.g., a person, an organization, a company, etc.). In some examples, the parent identifier 154 uniquely identifies and distinguishes the entity from others within a system. In some examples, the parent identifier 154 can be a unique identifier (UID), a decentralized user identifier (DID), or a universally unique identifier (UUID). In some examples, the card manager 139 can be executed to generate and issue a parent identifier 154 to a user requesting a parent card 118. In other examples, the user requesting the parent card 118 is already associated with a parent identifier 154 and the card manager 139 can be executed to use the existing parent identifier 154.

A card identifier 160 can represent an alphanumeric or numeric code used to identify specific card data 166. In some examples, the card identifier 160 can be used to generate and/or issue a specific card to a user. For example, a card identifier 160 “CV123” could indicate a child card 115 for a medication voucher can be generated and/or issued to a patient. In other examples, a card identifier 160 can represent an alphanumeric or numeric code used to select a parent card 118 or a child card 115 based at least in part on the operating system of the recipient device 103 or the provider device 106 requesting the card. For example, a card identifier 160 “IOS123” could indicate a card for an APPLE® device can be generated and/or issued to the user.

Card data 166 can represent various data related to a parent card 118 or a child card 115. In some examples, card data 166 can have card family data. For example, card data 166 could have a list of issued parent cards 118 and issued child cards 115 associated with each parent card 118. In some examples, card data 166 can have a variety of data related to the display of a parent card 118 or a child card 115 on the display 124 of a recipient device 103 or provider device 106. For example, card data 166 could have logos, offer details, drug indications, patient instructions, URLs, etc.

A card record 169 can represent a variety of data associated with a digital card 133 (e.g., a child card 115 or a parent card 118). In some examples, a card record 169 can include a card identifier 160, card data 166, a parent identifier 154, identity data 151, or a combination of any thereof. In some examples, a card record 169 can be encrypted or data contained within the card record 169 can be encrypted.

Next, a general description of the operation of the various components of the network environment 100 is provided. Although the following description provides one illustrative example of the operations of and interactions between the various components of the network environment 100, other operations and interactions are also encompassed by the various embodiments of the present disclosure. More detailed discussion of the operations of individual components is provided in the discussion accompanying the subsequent drawings.

To begin, a card manager 139 can be executed to receive a child card request 121. The card manager 139 could then be executed to identify a parent identifier 154 and a card identifier 160 based at least in part on the child card request 121. The card manager 139 can then be executed to establish a connection with a wallet application 112. The card manager 139 could then be executed to issue, to the wallet application 112, a child card 115 based at least in part on the parent identifier 154 and the card identifier 160. In some examples, the card manager 139 could further be executed to receive event data 136 associated with the child card 115 and notify a user based at least in part on the event data 136 and the parent identifier 154.

In some examples, the card manager 139 could be executed to receive a parent card request 145. The card manager 139 could then be executed to identify a parent identifier 154 and a card identifier 160 based at least in part on the parent card request 145. The card manager 139 could then be executed to establish a connection with a wallet application 112. The card manager 139 could further be executed to issue, to the wallet application 112, a parent card 118 based at least in part on the parent identifier 154 and the card identifier 160. In some examples, the parent card 118 could have a code. In some examples, the code could have a link configured to send a child card request 121.

In some examples, the card manager 139 could be executed to receive a plurality of child card requests 121. The card manager 139 could then be executed to identify a parent identifier 154 and a card identifier 160 based at least in part on the individual child card requests 121. In some examples, the card manager 139 could be executed to establish a connection with a wallet application 112. The card manager 139 could then be executed to issue, to the wallet application 112, a plurality of child cards 115 based at least in part on the parent identifiers 154 and the card identifiers 160.

In some examples, the card manager 139 could be executed to receive event data 136 associated with a child card 115 and update the child card 115 based at least in part on the event data 136. In some examples, the card manager 139 could be executed to receive event data 136 associated with a parent identifier 154 and update one or more child cards 115 associated with the parent identifier 154 based at least in part on the event data 136.

In some examples, an effect of the processes described herein, and operation of the various components of the network environment 100, is to generate and provide a child card 115 in real-time.

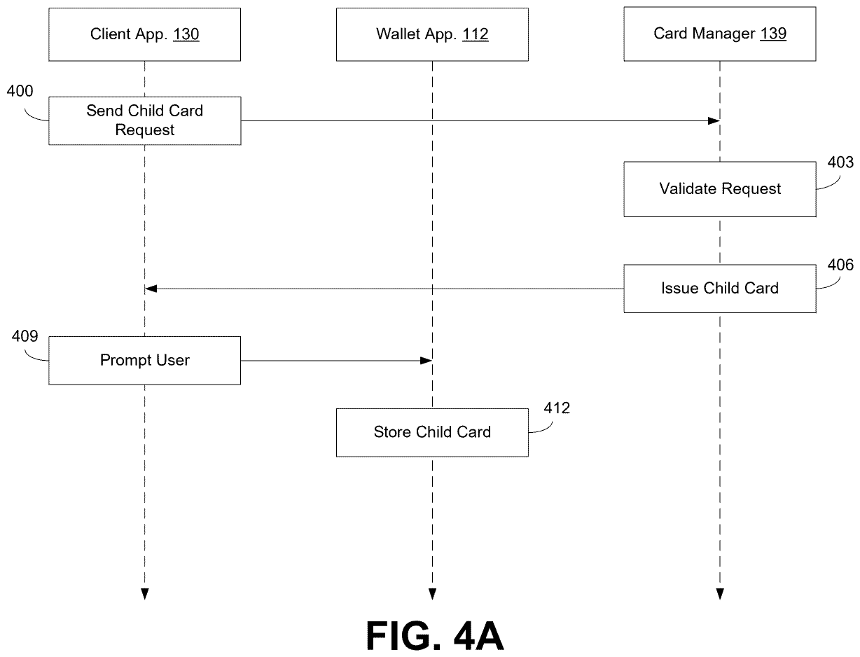

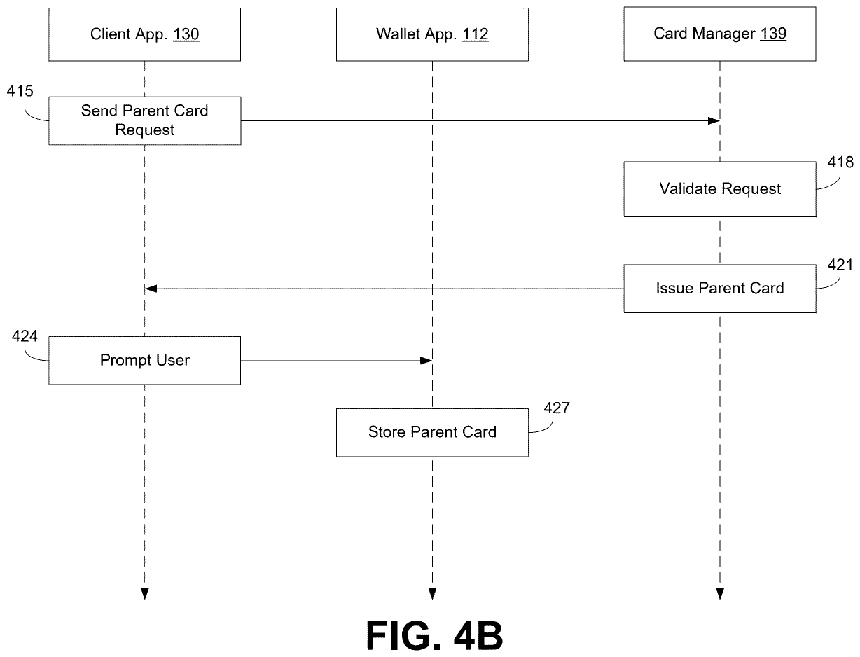

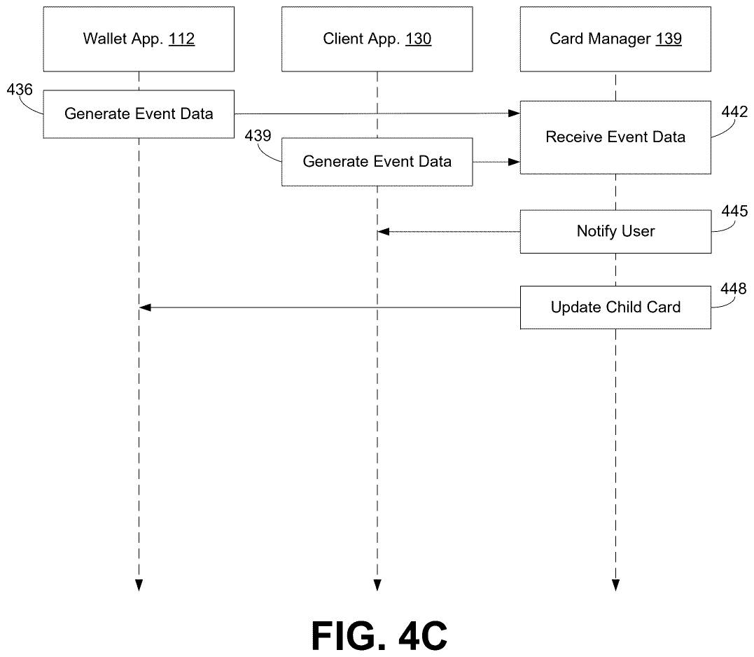

FIGS. 4A-4C show sequence diagrams which provide examples of the interactions between the various components of the network environment 100 according to various embodiments of the present disclosure. As an alternative, the sequence diagrams of FIGS. 4A-4C can be viewed as depicting examples of elements of methods implemented within the network environment 100.

As shown at block 400, the client application 130 can be executed to send a child card request 121 for a child card 115 from a client through a user interface 109. In some examples, a client application 130 can be executed to call a function to send a child card request 121 for a child card 115 and provide a parent identifier 154 and/or a card identifier 160 as arguments to the function. In some examples, the client application 130 can be executed to send a child card request 121 for a child card 115 after a user scans a code or activates a link. In some examples, the client application 130 can be executed to obtain a parent identifier 154 and/or a card identifier 160 from a parent card 118.

At block 403, the card manager 139 can be executed to validate the child card request 121. In some examples, the card manager 139 can be executed to call a function to check a user's identity and provide identification data 151 as an argument to the function. In some examples, the card manager 139 can be executed to call a function to identify a parent identifier 154 and/or a card identifier 160 and provide the child card request 121 as an argument to the function. In some examples, the parent identifier 154 and/or the card identifier 160 can be encrypted in the child card request 121 and the card manager 139 can be executed to decrypt the child card request 121.

At block 406, the card manager 139 can be executed to issue a child card 115 to the client app 130. In some examples, the card manager 139 can be executed to send a response having a child card 115 file (such as a .pkpass file for APPLE® wallet), a child card 115 payload (such as a JavaScript Object Notation (JSON) payload for GOOGLE® wallet), or a URL pointing to the child card 115 data to the client app 130. In some examples, the card manager 139 can be executed to call a function to issue a child card 115 to a client app 130 and provide a file, a payload, or a URL as an argument to the function. In some examples, the card manager 139 can be executed to issue a child card 115 to the client app. 130 in real time after receiving a child card request 121.

At block 409, the client app 130 could be executed to prompt a user to use his or her wallet application 112 to accept and store the child card 115. For example, the card manager 139 could be executed to send a matrix bar code (e.g., a QR code, a linear barcode, a data matrix, etc.) to the client application 130, which the client application 130 could show on a display 124 of a recipient device 103. For example, the card manager 139 could be executed to send a connection message or request to the client application 130, which could then relay or pass on the message to the wallet application 112 executed by the recipient device 103. In response, the wallet application 112 could display a prompt, or cause the client application 130 to display a prompt, to obtain the approval of the user to establish the connection between the wallet application 112 and the card manager 139. For example, the user could use his or her wallet application 112 on a second recipient device 103 to scan the matrix bar code shown on the display 124 of the recipient device 103 that is executing the client application 130 in order to store the child card 115.

At block 412, the wallet application 112 can be executed to store the child card 115. In some examples, the wallet app 112 can be executed to call a function to store the child card 115 and provide the child card 115 as an argument to the function. In some examples, the wallet app 112 can be executed to validate a signature of the card manager 139 on the child card 115. In some examples, the wallet app 112 can be executed to display a preview of the child card 115 on the user interface 109 of the recipient device 103 before storing the child card 115. Referring next to FIG. 4B, shown is a sequence diagram depicting the interactions between the various components of the network environment 100 according to various embodiments of the present disclosure. As an alternative, the sequence diagram of FIG. 4B can be viewed as depicting an example of elements of a method implemented within the network environment 100.

As shown at block 415, the client application 130 can be executed to send a parent card request 145 for a parent card 118 from a client through a user interface 109. In some examples, a client application 130 can be executed to call a function to send a parent card request 145 for a parent card 118 and provide a parent identifier 154 and/or a card identifier 160 as arguments to the function. In some examples, the client application 130 can be executed to send a parent card request 145 for a parent card 118 after a user scans a code or activates a link. In some examples, the client application 130 can be executed to obtain a parent identifier 154 and/or a card identifier 160 from the card manager 139.

At block 418, the card manager 139 can be executed to validate the parent card request 145. In some examples, the card manager 139 can be executed to call a function to check a user's identity and provide identification data 151 as an argument to the function. In some examples, the card manager 139 can be executed to call a function to identify a parent identifier 154 and/or a card identifier 160 and provide the parent card request 145 as an argument to the function. In some examples, the parent identifier 154 and/or the card identifier 160 can be encrypted in the parent card request 145 and the card manager 139 can be executed to decrypt the parent card request 145.

At block 421, the card manager 139 can be executed to issue a parent card 118 to the client app 130. In some examples, the card manager 139 can be executed to send response having a parent card 118 file (such as a .pkpass file for APPLE® wallet), a parent card 118 payload (such as a JSON payload for GOOGLE® wallet), or a URL pointing to the parent card 118 data to the client app 130. In some examples, the card manager 139 can be executed to call a function to issue a parent card 118 to a client app 130 and provide a file, a payload, or a URL as an argument to the function. In some examples, the card manager 139 can be executed to issue a parent card 118 to the client app. 130 in real time after receiving the parent card request 145.

At block 424, the client app 130 could be executed to prompt a user to use his or her wallet application 112 to accept and store the parent card 118. For example, the card manager 139 could be executed to send a matrix bar code (e.g., a QR code, a linear barcode, a data matrix, etc.) to the client application 130, which the client application 130 could show on a display 124 of a provider device 106. For example, the card manager 139 could be executed to send a connection message or request to the client application 130, which could then relay or pass on the message to the wallet app 112 executed by the provider device 106. In response, the wallet app 112 could display a prompt, or cause the client app 130 to display a prompt, to obtain the approval of the user to establish the connection between the wallet app 112 and the card manager 139. For example, the user could use his or her wallet application 112 on a second provider device 106 to scan the matrix bar code shown on the display 124 of the provider device 106 that is executing the client application 130 in order to store the parent card 118.

At block 427, the wallet application 112 can be executed to store the parent card 118. In some examples, the wallet app 112 could be executed to call a function to store the parent card 118 and provide the parent card 118 as an argument to the function. In some examples, the wallet app 112 an be executed to validate a signature of the card manager 139 on the parent card 118. In some examples, the wallet app 112 can be executed to display a preview of the parent card 118 on the user interface 109 of the provider device 106 before storing the parent card 118.

Referring next to FIG. 4C, shown is a sequence diagram depicting the interactions between the various components of the network environment 100 according to various embodiments of the present disclosure. As an alternative, the sequence diagram of FIG. 4C can be viewed as depicting an example of elements of a method implemented within the network environment 100.

At block 436, the wallet app 112 can be executed to generate event data 136. In some examples, the wallet app 112 can call a function to generate event data 136 and provide card data 166 or other data (e.g., transaction data, card use data, if a card was deleted, etc.) as arguments to the function. The wallet app 112 can be executed to generate event data 136 periodically or in response to identifying certain trigger events (e.g., a transaction with a card, deletion of a card, a transaction was made by the user at a pharmacy, a card was used by a user, etc.). In some examples, the wallet app 112 can be executed to send the event data 136 to the card manager 139.

At block 439, the client app 130 can be executed to generate event data 136. In some examples, the client app 130 can call a function to generate event data 136 and provide data, e.g. location data, a time and date of card expiration, a time and date of offer expiration, a time and date for refilling a medication, offer changes and updates, etc., as arguments to the function. The client app 130 can be executed to generate event data 136 periodically or in response to identifying certain trigger events (e.g., the user is located at a pharmacy, the card expiration date has passed or is approaching, a medication is due for a refill, the offer terms and conditions have been modified, etc.). In some examples, the client app 130 can be executed to send the event data 136 to the card manager 139.

At block 442, the card manager 139 can be executed to receive event data 136 from a wallet application 112, a client application 130, or both. In some examples, the card manager 139 can be executed to call a function to retrieve event data 136 and provide one or more parameters as arguments to the function. For example, the event data 136 could be expiration of a voucher on a child card 115 and the card manager 139 could be executed to retrieve the event data 136 related to the expiration of the child card 115 and provide a date and/or time range as arguments to the function. In another example, the parameters could be event data 136 related to the recipient device 103 or the provider device 106 being in or near a certain geographical location. In some examples, the event data 136 could be automatically sent to the card manager 139 upon the occurrence of a trigger (e.g., cancellation of an offer, use of the child card 115, expiration of an offer, etc.).

At block 445, the card manager 139 can be executed to notify a user. In some examples, the card manager 139 can be executed to send a notification to a client application 130 for display on the user interface 109 of a recipient device 103 or a provider device 106. In some examples, the card manager 139 can be executed to send a short message service (SMS) message to the user associated with the card. In some examples, the card manager 139 can be executed to call a function to cause a client application 130 to display a message on the user interface 109 of a recipient device 103 or a provider device 106 and provide the message as an argument to the function. In some embodiments, the notification could be a sound, an image, a message, or a combination of any thereof.

At block 448, the card manager 139 can be executed to update the child card 115 based at least in part on the event data 136. In some examples, the card manager 139 can be executed to call a function to issue a new child card 115 to the wallet application 112 and provide the new child card 115 as an argument to the function. In other examples, the card manager 139 can be executed to call a function to modify the child card 115 stored in the wallet application 112 and provide the modification as an argument to the function. For example, the card manager 139 can be executed to update the expiration date on a child card 115 that is a voucher.

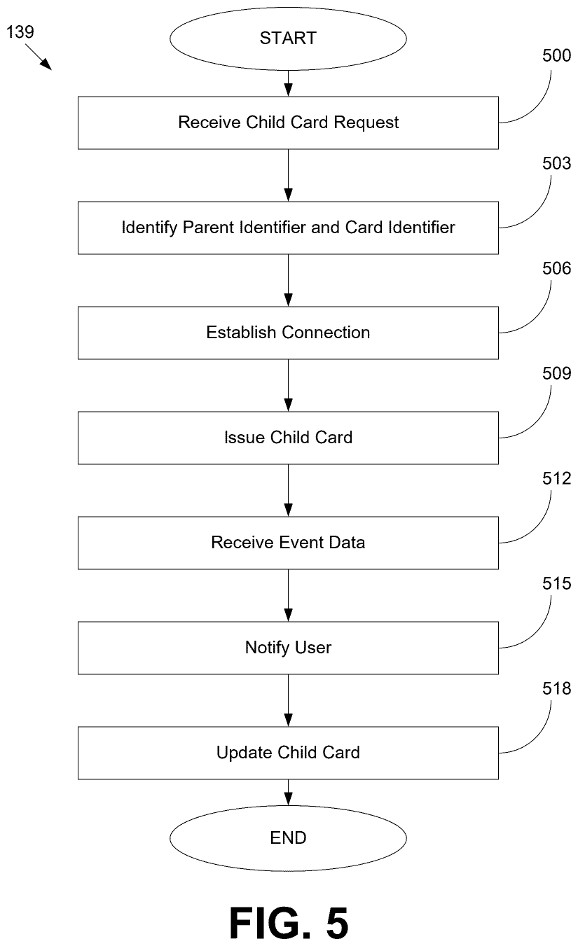

Referring next to FIG. 5, shown is a flowchart that provides one example of the operation of a portion of the card manager 139. The flowchart of FIG. 5 provides merely an example of the many different types of functional arrangements that can be employed to implement the operation of the depicted portion of the card manager 139. As an alternative, the flowchart of FIG. 5 can be viewed as depicting an example of elements of a method implemented within the network environment 100.

As shown at block 500, the card manager 139 can be executed to receive a child card request 121 for a child card 115. In some examples, the card manager 139 can be executed to call a function to retrieve a child card request 121 for a child card 115 and provide a parent identifier 154 and/or a card identifier 160 as arguments to the function. In some examples, the card manager 139 can be executed to receive a child card request 121 for a child card 115 after a user scans a code or activates a link.

At block 503, the card manager 139 can be executed to identify a parent identifier 154 and/or a card identifier 160. In some examples, the card manager 139 can be executed to call a function to identify a parent identifier 154 and a card identifier 160 and provide a child card request 121 as an argument to the function. In some examples, the parent identifier 154 and/or the card identifier 160 can be encrypted in the child card request 121 and the card manager 139 can be executed to decrypt the child card request 121.

At block 506, the card manager 139 can be executed to establish a connection with the wallet application 112. In some examples, this can be accomplished according to the specification of any version of the DIDcomm protocol as published by the Decentralized Identity Foundation (DIF). In other examples, the connection can be established through a direct wireless connection. In some examples, the card manager 139 can be executed to call a function to establish a connection with the wallet application 112 and provide identification data 151 as an argument to the function. In some embodiments, the card manager 139 could first be executed to make a request to establish a DIDComm connection with a client app 130 and/or a wallet app 112 on a recipient device 103. For example, the card manager 139 could send a matrix bar code (e.g., a QR code, a linear barcode, a data matrix, etc.) to the client app 130, which the client app 130 could show on a display 124 of a recipient device 103. As another example, the card manager 139 could send a connection message or request to the client app 130, which could then relay or pass on the message to a wallet app 112 executed by the recipient device 103. In response, the wallet app 112 could display a prompt, or cause the client app 130 to display a prompt to obtain the approval of the user to establish a connection between the wallet app 112 and the card manager 139.

At block 509, the card manager 139 can be executed to issue a child card 115 to the wallet application 112. In some examples, the card manager 139 can be executed to call a function that issues the child card 115 to the wallet application 112 and provide card data 166 as an argument to the function. In other examples, the card manager 139 can be executed to call a function that issues the child card 115 to the wallet application 112 and provide a parent identifier 154 and a card identifier 160 as arguments to the function. The card manager 139 can then be executed to send the child card 115 to the wallet application 112. In some examples, the card manager 139 can be executed to issue the child card 115 directly to a wallet app 112 on a recipient device 103. In some examples, a child card request 121 launches the wallet app 112 directly through a deep link and the wallet app 112 can parse the child card 115 directly from the card manager 139. In some examples, the wallet app 112 can be executed to download the child card 115 from the card manager 139. In some examples, the card manager 139 can be executed to issue a child card 115 to the wallet application 112 in real time after receiving a child card request 121.

At block 512, the card manager 139 can be executed to receive event data 136 from a wallet application 112, a client application 130, or both. In some examples, the card manager 139 can be executed to call a function to retrieve event data 136 and provide one or more parameters as arguments to the function. For example, the event data 136 could be expiration of a voucher on a child card 115 and the card manager 139 could be executed to retrieve the event data 136 related to the expiration of the child card 115 and provide a date and/or time range as arguments to the function. In another example, the parameters could be event data 136 related to the recipient device 103 being in or near a certain geographical location. In some examples, the event data 136 could be automatically sent to the card manager 139 upon the occurrence of a trigger (e.g., cancellation of an offer, use of the child card 115, expiration of an offer, etc.).

At block 515, the card manager 139 can be executed to notify a user. In some examples, the card manager 139 can be executed to send a notification to a client application 130 for display on the user interface 109 of a recipient device 103, a provider device 106, or an administrator device 148. In some examples, the card manager 139 can be executed to send a short message service (SMS) message to the user associated with the card. In some examples, the card manager 139 can be executed to call a function to cause a client application 130 to display a message on the user interface 109 of a recipient device 103, a provider device 106, or an administrator device 148 and provide the message as an argument to the function. In some embodiments, the notification could be a sound, an image, a message, or a combination of any thereof.

At block 518, the card manager 139 can be executed to update the child card 115 based at least in part on the event data 136. In some examples, the card manager 139 can be executed to call a function to issue a new child card 115 to the wallet application 112 and provide the new child card 115 as an argument to the function. In other examples, the card manager 139 can be executed to call a function to modify the child card 115 stored in the wallet application 112 and provide the modification as an argument to the function. For example, the card manager 139 can be executed to update the expiration date on a child card 115 that is a voucher.

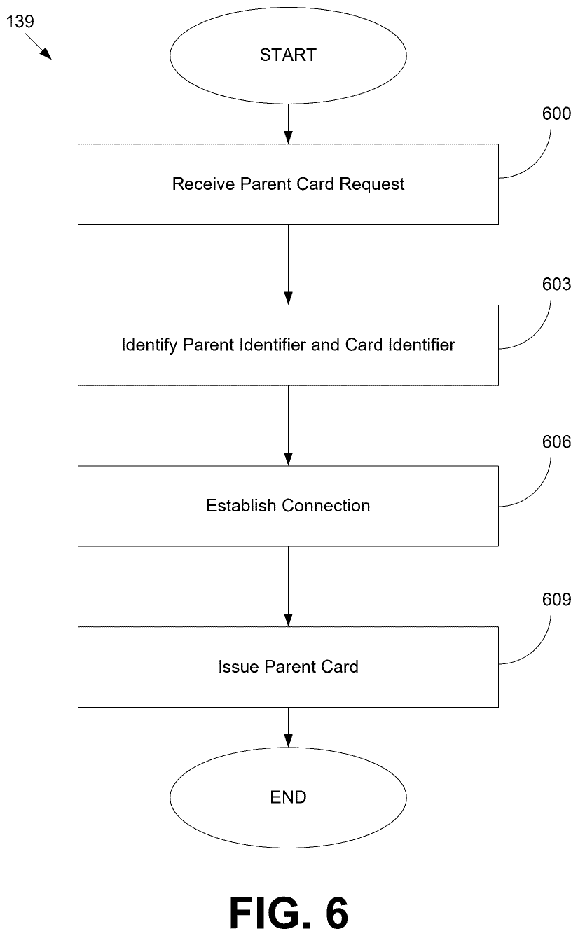

Referring next to FIG. 6, shown is a flowchart that provides one example of the operation of a portion of the card manager 139. The flowchart of FIG. 6 provides merely an example of the many different types of functional arrangements that can be employed to implement the operation of the depicted portion of the card manager 139. As an alternative, the flowchart of FIG. 6 can be viewed as depicting an example of elements of a method implemented within the network environment 100.

As shown at block 600, the card manager 139 can be executed to receive a parent card request 145 for a parent card 118. In some examples, the card manager 139 can be executed to call a function to retrieve a parent card request 145 for a parent card 118 and provide a parent identifier 154 and/or a card identifier 160 as arguments to the function. In some examples, the card manager 139 can be executed to receive a parent card request 145 for a parent card 118 after a user scans a code or activates a link.

At block 603, the card manager 139 can be executed to identify a parent identifier 154 and/or a card identifier 160. In some examples, the card manager 139 can be executed to call a function to identify a parent identifier 154 and a card identifier 160 and provide a parent card request 145 as an argument to the function. In some examples, the parent identifier 154 and/or the card identifier 160 can be encrypted in the parent card request 145 and the card manager 139 can be executed to decrypt the parent card request 145.

At block 606, the card manager 139 can be executed to establish a connection with the wallet application 112. In some examples, this can be accomplished according to the specification of any version of the DIDcomm protocol as published by the Decentralized Identity Foundation (DIF). In other examples, the connection can be established through a direct wireless connection. In some examples, the card manager 139 can be executed to call a function to establish a connection with the wallet application 112 and provide identification data 151 as an argument to the function. In some embodiments, the card manager 139 could first be executed to make a request to establish a DIDComm connection with a client app 130 and/or a wallet app 112 on a provider device 106. For example, the card manager 139 could send a matrix bar code (e.g., a QR code, a linear barcode, a data matrix, etc.) to the client app 130, which the client app 130 could show on a display 124 of a provider device 106. As another example, the card manager 139 could send a connection message or request to the client app 130, which could then relay or pass on the message to a wallet app 112 executed by the provider device 106. In response, the wallet app 112 could display a prompt, or cause the client app 130 to display a prompt to obtain the approval of the user to establish a connection between the wallet app 112 and the card manager 139.

At block 609, the card manager 139 can be executed to issue a parent card 118 to the wallet application 112. In some examples, the card manager 139 can be executed to call a function that issues the parent card 118 to the wallet application 112 and provide card data 166 as an argument to the function. In other examples, the card manager 139 can be executed to call a function that issues the parent card 118 to the wallet application 112 and provide a parent identifier 154 and a card identifier 160 as arguments to the function. The card manager 139 can then be executed to send the parent card 118 to the wallet application 112. In some examples, the card manager 139 can be executed to issue the parent card 118 directly to a wallet app 112 on a provider device 106. In some examples, a parent card request 145 launches the wallet app 112 directly through a deep link and the wallet app 112 can parse the parent card 118 directly from the card manager 139. In some examples, the wallet app 112 can be executed to download the parent card 118 from the card manager 139. In some examples, the card manager 139 can be executed to issue a parent card 118 to the wallet application 112 in real time after receiving a parent card request 145.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 142.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system of managing user credentials, the system comprising:
a memory storing machine-readable instructions; and
at least one processor executing the machine-readable instructions, wherein the machine-readable instructions include:
receiving a secondary credential request, wherein the secondary credential request includes a detection of an activation code associated with a primary credential;
in response to receipt of the secondary credential request, identifying a primary identifier and a credential identifier based on the secondary credential request;
establishing a wireless connection with a wallet application that is remote from the system;
issuing, to the wallet application, a secondary credential based on the primary identifier and the credential identifier, wherein:
the secondary credential is a non-payment credential, and
the credential identifier indicates a maximum number of uses of the secondary credential; and
in response to receiving event data that is both (i) associated with the secondary credential and (ii) indicative of a use of the secondary credential, updating the secondary credential to reduce a number of remaining uses of the secondary credential.

2. The system of claim 1, wherein the machine-readable instructions include:
receiving event data associated with the secondary credential; and
notifying a user based on the event data and the primary identifier.

3. The system of claim 1, wherein:
the credential identifier is a second credential identifier,
the wireless connection is a second connection,
the wallet application is a second wallet application, and
the machine-readable instructions include:
receiving a primary credential request;
in response to receipt of the primary credential request, identifying the primary identifier and a first credential identifier based on the primary credential request;
establishing a first connection with a first wallet application; and
issuing, to the first wallet application, a primary credential based on the primary identifier and the first credential identifier, wherein the primary credential includes a code.

4. The system of claim 3, wherein the code includes a link configured to send the secondary credential request.

5. The system of claim 1, wherein:
the secondary credential request is a first secondary credential request,
the credential identifier is a first credential identifier,
the secondary credential is a first secondary credential, and
the machine-readable instructions include:
receiving a second secondary credential request;
in response to receipt of the second secondary credential request, identifying the primary identifier and a second credential identifier based on the second secondary credential request;
establishing a wireless connection with the wallet application; and
issuing, to the wallet application, a second secondary credential based on the primary identifier and the second credential identifier.

6. The system of claim 1, wherein the machine-readable instructions include:
receive-receiving event data associated with the secondary credential; and
updating the secondary credential based on the event data.

7. The system of claim 1, wherein the machine-readable instructions include:
receiving event data associated with the primary identifier; and
updating one or more secondary credentials associated with the primary identifier based on the event data.

8. A method, comprising:
receiving, at a computing device, a secondary credential request, wherein the secondary credential request includes a detection of an activation code associated with a primary credential;
in response to receiving the secondary credential request, identifying a primary identifier and a credential identifier based on the secondary credential request;
establishing a wireless connection with a remote wallet application;
programmatically issuing, to the remote wallet application, a secondary credential based on the primary identifier and the credential identifier, wherein:
the secondary credential is a non-payment credential, and
the credential identifier indicates a maximum number of uses of the secondary credential; and
in response to receiving event data that is both (i) associated with the secondary credential and (ii) indicative of a use of the secondary credential, updating the secondary credential to reduce a number of remaining uses of the secondary credential.

9. The method of claim 8, further comprising:
receiving event data associated with the secondary credential; and
notifying a user based on the event data and the primary identifier.

10. The method of claim 8, wherein:
the credential identifier is a second credential identifier,
the wireless connection is a second connection,
the remote wallet application is a second wallet application, and
the method further comprises:
receiving a primary credential request;
in response to receiving the primary credential request, identifying the primary identifier and a first credential identifier based on the primary credential request;
establishing a first connection with a first wallet application; and
issuing, to the first wallet application, a primary credential based on the primary identifier and the first credential identifier, wherein the primary credential includes a code.

11. The method of claim 10, wherein the code includes a link configured to send the secondary credential request.

12. The method of claim 8, wherein:
the secondary credential request is a first secondary credential request,
the credential identifier is a first credential identifier,
the secondary credential is a first secondary credential, and
the method further comprises:
receiving a second secondary credential request;
in response to receiving the second secondary credential request, identifying the primary identifier and a second credential identifier based on the second secondary credential request;
establishing a wireless connection with the remote wallet application; and
issuing, to the remote wallet application, a second secondary credential based on the primary identifier and the second credential identifier.

13. The method of claim 8, further comprising:
receiving event data associated with the secondary credential; and
updating the secondary credential based on the event data.

14. The method of claim 8, further comprising:
receiving event data associated with the primary identifier; and
updating one or more secondary credentials associated with the primary identifier based on the event data.

15. A non-transitory, computer-readable medium, comprising machine-readable instructions, the machine-readable instructions including:
receiving a secondary credential request, wherein the secondary credential request includes a detection of an activation code associated with a primary credential;
in response to receipt of the secondary credential request, identifying a primary identifier and a credential identifier based on the secondary credential request;
establishing a wireless connection with a remote wallet application;
issuing to the remote wallet application, a secondary credential based on the primary identifier and the credential identifier, wherein:
the secondary credential is a non-payment credential, and
the credential identifier indicates a maximum number of uses of the secondary credential; and
in response to receiving event data that is both (i) associated with the secondary credential and (ii) indicative of a use of the secondary credential, updating the secondary credential to reduce a number of remaining uses of the secondary credential.

16. The non-transitory, computer-readable medium of claim 15, wherein the machine-readable instructions include:
receiving event data associated with the secondary credential; and
notifying a user based on the event data and the primary identifier.

17. The non-transitory, computer-readable medium of claim 15, wherein:
the credential identifier is a second credential identifier,
the wireless connection is a second connection,
the remote wallet application is a second wallet application, and
the machine-readable instructions include:
receiving a primary credential request;
in response to receipt of the primary credential request, identifying the primary identifier and a first credential identifier based on the primary credential request;
establishing a first connection with a first wallet application; and
issuing to the first wallet application, a primary credential based on the primary identifier and the first credential identifier, wherein the primary credential includes a code.

18. The non-transitory, computer-readable medium of claim 15, wherein the machine-readable instructions include:
receiving event data associated with the secondary credential; and
updating the secondary credential based on the event data.

19. The non-transitory, computer-readable medium of claim 15, wherein the machine-readable instructions include:
receiving event data associated with the primary identifier; and
updating one or more secondary credentials associated with the primary identifier based on the event data.

20. The non-transitory, computer-readable medium of claim 17, wherein the code includes a link configured to send the secondary credential request.
